(19) United States
(12) Patent Application Publication
(10) Pub. No.: US 2010/0212199 A1
(43) Pub. Date: Aug. 26, 2010

(54) Vehicle-Mounted Windsock

(76) Inventor: Gregory Bruce Edmonds, Overland Park, KS (US)

Correspondence Address: INTELLECTUAL PROPERTY CENTER, LLC, 9233 WARD PARKWAY, SUITE 100, KANSAS CITY, MO, 64114, US

(21) Appl. No.: 12/772,821

(22) Filed: May 3, 2010

Related U.S. Application Data
(63) Continuation-in-part of application No. 12/217,591, filed on Jul. 7, 2008.

(51) Int. Cl. G09F 21/04

(52) U.S. Cl. 40/581; 40/541

(57) ABSTRACT

The present invention is directed to a new and improved method and apparatus for a mobile aerodynamic illumination apparatus having a graphic and secured to an automobile the apparatus including a modular base joined to a stem extending from said modular base fastened to a windsock having an inner and outer adapted to receive the graphic presenting a visual display surface, said windsock further comprising an illuminator having a lens assembly surrounding a light source and in visual communication with a light tunnel, said lens assembly including a lens, a first and second reflector said light source fixed to one end of said light tunnel and operable to emit light, the first and second reflectors being spaced apart and each presenting a reflective curvilinear surface whereby said emitted light is dispersed to said visual display surface for illumination of said graphic.

### CROSS REFERENCE TO RELATED APPLICATION

This application is continuation in part non-provisional application claiming the benefit of the earlier filed U.S. Non-Provisional application Ser. No. 12/217,591 filed on Jul. 7, 2008 and the earlier filed U.S. Provisional Application 60/948,551 filed on Jul. 9, 2007, the contents of which are hereby incorporated by reference.

### FIELD OF THE INVENTION

The present invention generally relates to a graphic display device and more specifically to a vehicle mounted illumination device for displaying a graphic associated with a sporting event, team, business, or promotional uses.

### BACKGROUND OF THE INVENTION

Many sporting events are held at night or extend into the night time. During these sporting events, many fans show their support of their team with various team memorabilia including clothes, decals and signs. In addition, some fans show their support with flags and windsocks attached to their vehicle. There are different types of existing car-mounted flags and windsocks used to display graphics while a vehicle is in motion. However, some of these existing car-mounted flags and windsock units on the market are not illuminated and, therefore, not visible at night. In addition, some of these flags and windsocks utilize nondurable materials and utilize a design which lacks sufficient support to prevent undesired oscillations of the windsock or flag during vehicle movement, limiting the visibility of any graphics associated with windsock or flag or broken flag stem. In addition, damage may occur to a vehicle as a result of undesired oscillation of the flag, windsock or support during movement of the vehicle.

One prior attempt to provide a flag connected to a vehicle included U.S. Pat. No. 3,305,961, which utilized a hood-mounted signal panel with an internal lamp. However, as disclosed, the invention utilized a cord and plug that ran along the car exterior, into the car, and plugged into the car lighter. Other attempts include U.S. Pat. No. 4,002,138 and U.S. Des. Pat. No. 368,866. The '138 patent disclosed a non-illuminated, car-window mounted safety flag for warning approaching motorists that the vehicle was disabled. The '866 patent discloses a lighted wind sock with a limited support.

Heretofore, there exists a need for a car mountable illuminated windsock for displaying a graphic associated with a sporting event or sporting team, business; or common cause.

### SUMMARY OF THE INVENTION

The present invention provides an aerodynamic apparatus having a graphic and secured to an automobile and adapted for illumination, said apparatus comprising a modular base releasably joined to a distal end of a stem, said stem extending from said modular base to a proximal end fastened to a proximal end of a windsock having an inner surface and outer surface adapted to receive said graphic presenting a visual display surface, said windsock further comprising an illuminator comprising a lens assembly surrounding a light source and in visual communication with a light tunnel, said lens assembly including a lens, a first and second reflector, said light source operable to emit light and fixed to one end of said light tunnel and said first and second reflectors being spaced apart and each presenting a reflective curvilinear surface whereby said emitted light is dispersed to said visual display surface for illumination of said graphic.

The invention provides an illuminated apparatus for mobile display of team logos and graphics. Another object of the invention is to provide a vehicle-mounted, aerodynamic, apparatus for mobile display of team logos and graphics.

A further object of the invention is to provide a multi-purpose apparatus that can be re-mounted on different modes of transportation using similar mounting modules or bases.

Yet another object of the invention is to provide a mobile display apparatus that can be remotely controlled, either individually or in groups. Yet another object of the invention is to provide a decorative and styled apparatus for displaying team logos and graphics.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine for displaying and illuminating team or group logos, mascot images, colors, or other team or group graphics comprising: a graphics attachment ring that can be opened for graphics removal or closed for graphics capture, an aerodynamically shaped illuminator, an illuminator with side-emitting light distribution optics, an integral control section, a locking stem-to-base stem capture module, a single-action push-to-release stem capture module, an integral battery compartment, an on-board printed circuit board with LED'S and microprocessor, individualized or group remote control capabilities, made of plastic, and/or made of metal. The invention incorporates LED's as the light source behind the side-emitting illuminator, which illuminates the graphics. The invention also incorporates an aerodynamically “stylized” aspect not currently available with the car-mounted flag and windsock devices on the market.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is side view of an embodiment of the present invention.

FIG. 2 is a rear view of the embodiment of FIG. 1.

FIG. 3 is a sectional view of an exemplary stem in accordance with an embodiment of the present invention.

FIG. 4 is a view of an exemplary stem in accordance with an embodiment of the present invention.

FIG. 5 is a side view of an illuminator in accordance with an embodiment of the present invention.

FIG. 6 is an exploded side perspective view of the illuminator of FIG. 5.

FIG. 7 is an exploded side view of a portion of the illuminator of FIG. 5.

FIG. 8 is a front view of an exemplary modular base in accordance with an embodiment of the invention.

FIG. 9 is a side view of the modular base of FIG. 8.

FIG. 10 is a side view of a portion of the modular base of FIG. 9.

FIG. 11 is a top perspective exploded view of the modular base of FIG. 8 and FIG. 9.

FIG. 12 is a front view of an attachment ring in accordance with an embodiment of the invention.

FIG. 13 is a front view of an operational control in accordance with an embodiment of the invention.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

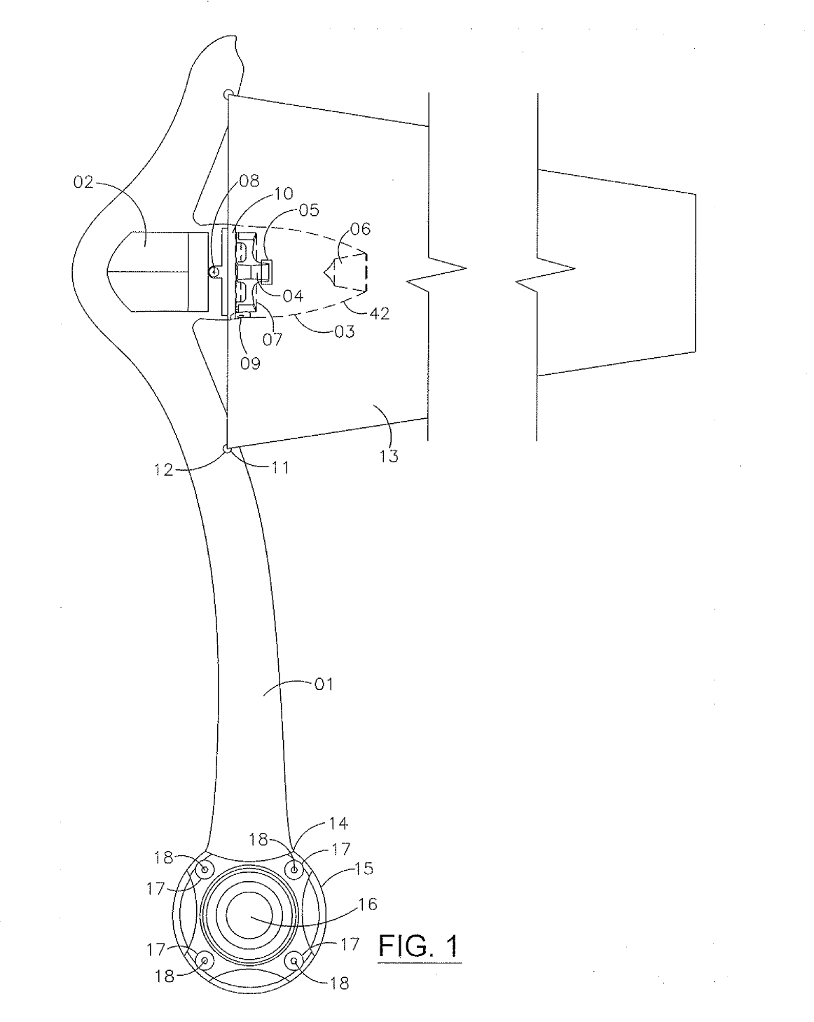

FIG. 1 depicts an embodiment of the vehicle mounted windsock. The embodiment is comprised of a windsock 13, a stem 01, and a modular base 15. The windsock 13 is aerodynamically shaped to receive air flow through its inner periphery. The windsock 13 is preferably frustoconical, having a major radius at a proximal end and a minor radius at a distal end. The major and minor radii may be dimensioned according to the desired aerodynamics and visual display surface 45, but preferably have radial distance of approximately 4.5″ and 2″ respectively. The outer surface 40 of the windsock 13 presents the visual display surface 45 which includes a graphic affixed to the outer surface 40 adapted for illumination. The windsock 13 is preferably formed from a durable air channeling material, such as nylon or polyester, which is suitable for use in varying wind and weather conditions.

In order to illuminate the outer surface 40 or the windsock 13, an illuminator 42 is disposed in the inner periphery of the windsock 13 at the proximal end thereof 13. The illuminator 42 disperses light along the inner surface 44 of the windsock 13, providing light to illuminate the visual display surface 40 from the inner surface 44. The illuminator 42 illustrated in FIG. 1 includes a light source 31, a light tunnel 04, a lens 05, a first light reflector 06, a second light reflector 07, and a lens assembly 03.

The light source 31 is located at one end of the lens assembly 03 and may utilize plural light emitting diodes (LEDs) 31 or other light sources consistent with the description herein. The plurality of LEDs is arranged as a cluster which emits multiple colors of light. For example, in an exemplary embodiment, red, green, blue, and white LEDs 31 are included in the cluster. The light source 31 is optionally mounted on a circuit board 10. Preferably, the light source 31 utilizes an operational control 09, which is depicted in FIG. 13 as a pair of selector buttons. In an exemplary embodiment, a first button 46 toggles power from a power supply to the circuit board 10, energizing the light source 31. Preferably, the circuit board 10 also includes a memory feature to restore the light source 31 to the last used operational mode. The operational modes may include on-off, gradual fading of one color to the next color, or a static color. A second selector button 48, in communication with the circuit board 10, may be momentarily depressed to selectively power individual LEDs or a combination of LEDs thereby presenting a different color with each momentary depression. Depressing and holding the second selector button 48 for a predetermined amount of time may force the operational cycle of the LEDs 31 to automatically change and gradually fade from one color to the next with no end to the cycle unless manually interrupted.

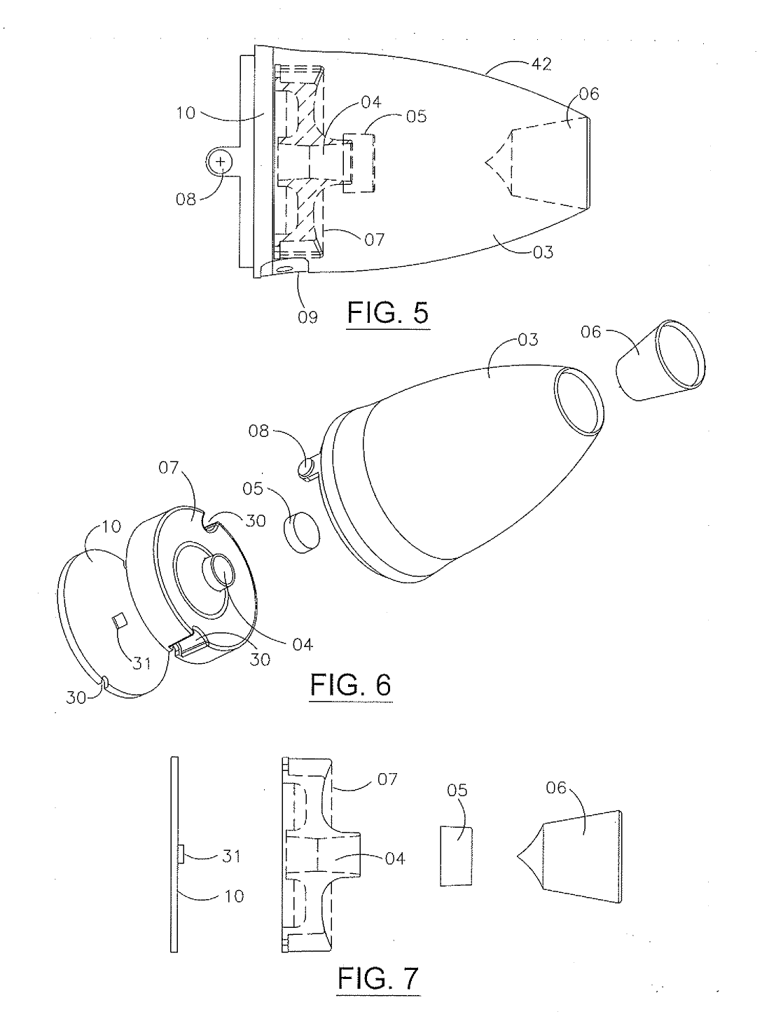

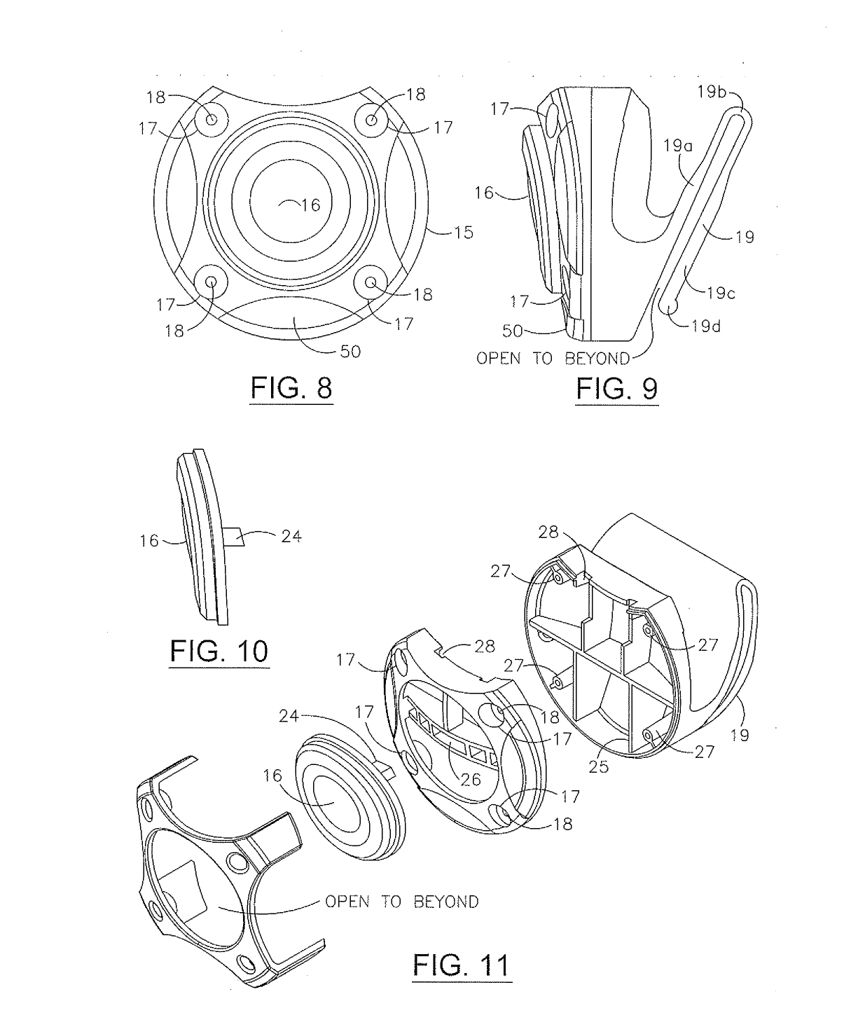

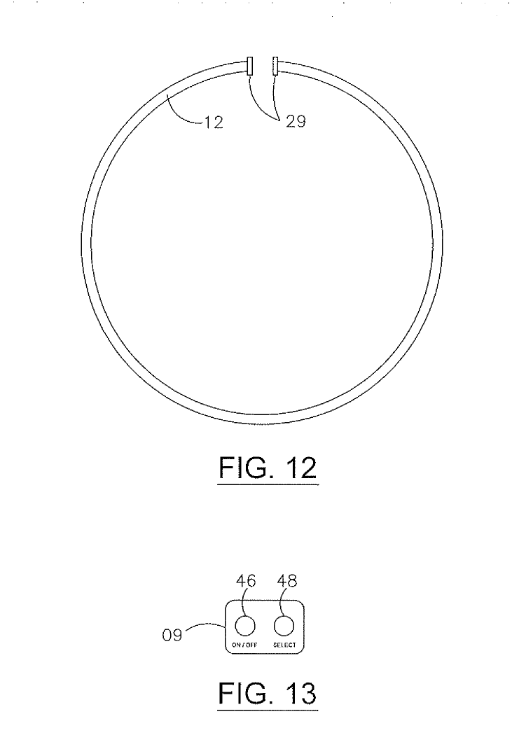

As illustrated in FIG. 5, the light tunnel 04 surrounds the light source 31 at one end of the light tunnel 04, the emitted light being directed towards the opposite end of the light tunnel 04. The illustrated light tunnel 04 is cylindrical and hollow, extending from the proximal end towards the distal end, including a reflective surface, presenting a path whereby the light travels from the proximal end towards the distal end of the light tunnel 04.

The lens 05 is composed of a semi-opaque, UV-stabilized material which diffuses light, and may be connected at the distal end of the light tunnel 04. As illustrated, the lens 05 includes a plurality of snap connections for securing the lens 05 to the light tunnel 04. In operation, the lens 05 scatters the light from the LEDs 32 reducing any hotspots and providing a more uniform, controlled light distribution. In one embodiment the lens 05 includes a rough or irregular surface (not pictured) to further scatter the emitted light from the light, source 31 prior to distribution to first and second reflectors 06, 07 and visual display surface 44, the surface being fabricated from a durable plastic material with appropriate ultraviolet stabilized properties.

The first light reflector 06 may be positioned near the distal end of the lens assembly 03, substantially coaxially from the light tunnel 04 and lens 05. The first light reflector 06 is adapted to receive a portion of the emitted light and may provide a visual barrier for the light source 31 from behind this embodiment. The first light reflector 06 may include a reflective curvilinear surface presenting varying angles of reflection for scattering received light. Various degrees of curvature along the curvilinear surface may be used to direct the received light to desired regions of the windsock 13. The preferred degrees of curvature for the first light reflector 06 result in a substantial portion of the reflected light dispersed outward along the proximal end of the windsock 13, with a portion of the emitted light being reflected over approximately one third of the windsock 13 and diffused towards the remaining portion of the windsock 13.

As illustrated in FIG. 5, the second light reflector 07 may be located between the first reflector 06 and the proximal end of the light tunnel 04. The emitted light is transmitted from the first reflector 06 towards the proximal end of the lens assembly 03. The second light reflector 07 may be secured to the light tunnel 04 to prevent undesired movement. Generally, the second light reflector 07 is oriented perpendicular to the coaxial axis of both the light tunnel 04 and the first light reflector 06. The second light reflector 07 is illustrated with a reflective curvilinear surface with differing portions of the surface preferably presenting various angles of reflection. Again, the degrees of curvature of the curvilinear surface may be used to desirably redirect the received light. In one embodiment, the configured curvature may result in a substantial portion of the reflected light passing the first reflector 06 while some light is passed around the second reflector 07 toward the distal end of the windsock 13. The configured curvature may present parabolic surfaces, as desired, to configure the emitted light preferred for illumination of the visual display surface 45.

The lens assembly 03 defines a perimeter around the light source 31, the light tunnel 04, the lens 05, the first light reflector 06, and the second light reflector 07. The lens assembly 03 may be composed of light conductive material, which facilitates dispersion of the emitted light, such as a clear, hard, weather and ultraviolet resistant material with an optional curvilinear surface that will allow substantially 100% light transmission with approximately 10% diffusion occurring at the outer lens face. Alternatively, light channels (not pictured) may be provided around the lens assembly 03 to diffuse the emitted light. The lens assembly 03 may optionally have a unitary configuration for releasable connection to protect the lens assembly 03 from the weather, the mechanical features being utilized to releasably secure the assembly, such as, but not limited to, alignment tabs 08, mechanical fasteners, and notch structures 30 as illustrated in FIG. 6.

One skilled in the art would appreciate that the dispersement of light to the surface of the windsock 13 may be altered by modifying one or more of the following: the intensity of the light source 31, the length or diameter of the light tunnel 04, the composition or curvature of the lens 05, the angles of curvature of the reflectors 06 07, the composition of the lens assembly 03, and the length or angle of curvature of the lens assembly 03.

Referring to FIG. 1, the windsock 13 may be releasably secured to the stem 01. The mechanical fastening system may include a plurality of openings 11 on the proximal end of the stem 01 and corresponding openings on the windsock 13 at its proximal end. Attachment rings 12 may be engaged through both an opening the windsock and a corresponding opening 11 of the stem 01 to releasably fasten the windsock 13 to the stem 01. Alternatively, the opening of the windsock 13 may be presented by a seam formed proximate the major periphery of the windsock 13 adapted for receipt of a structure and facilitating the semi-rigid structure of the windsock 13 in operation. An attachment ring 12 may be engaged through the opening presented by the seam, thereby providing structure around the major periphery of the windsock 13. The attachment ring 12 optionally includes ring attachment tabs 29 to restrict rotational motion of the windsock 13.

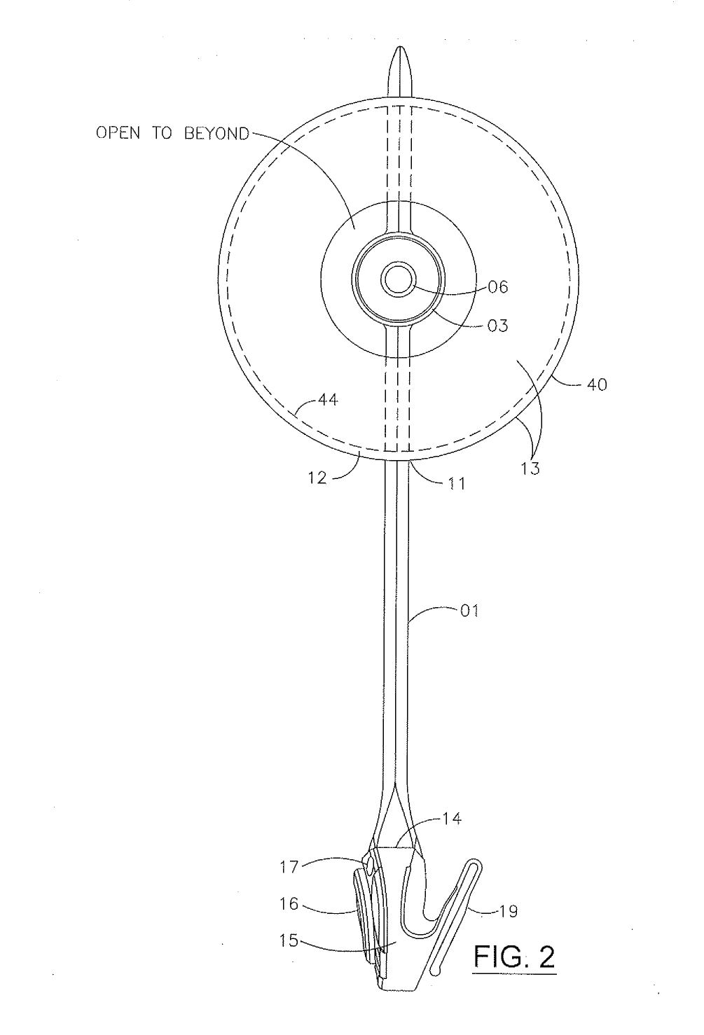

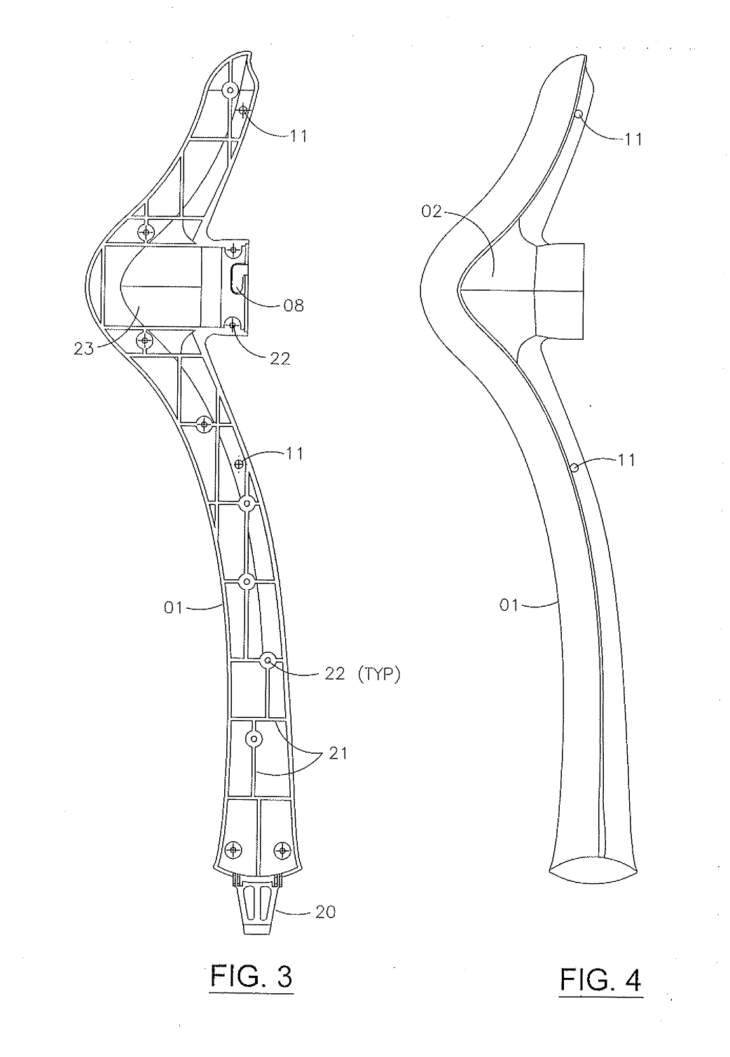

As illustrated in FIG. 4, the stem 01 may be an aerodynamically shaped structure, fabricated by using a rigid material having an arcuate region which is joined to the windsock 13 on its proximal end and joined to a modular base 15 on its distal end. The stem 01 is optionally comprised of two opposing, generally symmetric members which are mechanically fastened 22 to form the unitary stem 01. As depicted in FIG. 3, the stem 01 may use structural ribbing 21 in its interior in place of a fully rigid interior, in order to reduce the total mass and cost of the stem 01. The stem 01 optionally includes a water-tight compartment 23 dimensioned to receive a power supply such as batteries.

The stem 01 is secured to the modular base 15 for receipt by a vehicle structure. In an exemplary embodiment, as shown in FIGS. 3 and 11, the modular base 15 is releasably connected to the adapted stem 01 at insert 20, via activation arm 24, via channel 26, for ready release by button 16. The insert 20 extends from the distal end of the stem 01 and is complimentarily configured to the corresponding activation arm 24 associated with the modular base 15. Generally, the insert 20 has a frusto-triangular cross-section adapted for the passage through a guide opening 28 into a lockable position with activation arm 24. Upon engagement of the insert 20 by the activation arm 24, optional audio feedback may be provided to notify the user of secure engagement. In order to disengage the stem 01 from the modular base 15, the quick release button 16 may be depressed, causing an activation arm 24 to bias the insert inwardly relieving any mechanical pressure, and allowing disengagement of the insert 20, thereby facilitating removal of the stem 01 from the modular base 15. The modular base 15 may be housed 50, with exterior of the housing 50 a recessed opening 17, and a countersunk screw opening 18. The interior of the housing 50 contains base ribbing 25 and structure 27 to receive attachment screws.

Optionally, the corresponding channel 28 of the modular base 15 may be sized according to industry standards, allowing additional items to operate with the modular base 15.

As illustrated in FIG. 9, the modular base 15 may further include a clip 19 which has of a length of rigid material fixed to an arcuate recess, which is angled from the modular base 15 and extends vertically along an appending leg 19a and then to a ridge 19b and then down to a depending leg 19c, which is generally coplanar to the appending leg 19a, to a termination 19d. The radius of curvature of the arcuate recess may be adapted for a width of an automobile window to be sandwiched between the appending leg 19a and the depending leg 19c.

In operation, the stem 01 is secured to the windsock 13 via the circular attachment ring 12 and also secured to the modular base 15. The clip 19 of the modular base 15 is then secured to the automobile window. The operational control 09 is then used to activate and control the light source 31 thereby illuminating the windsock 13 and the visual display surface 45.

While the foregoing detailed description has disclosed several embodiments of the invention, it is to be understood that the above description is illustrative only and not limiting of the disclosed invention. It will be appreciated that the discussed embodiments and other unmentioned embodiments may be within the scope of the invention.

Having thus described the invention, what is claimed as new and desired to be secured by Letters Patent is as follows:

1. An aerodynamic illumination apparatus having a graphic and secured to an automobile, said apparatus comprising:
a modular base releasably joined to a distal end of a stem, said stem extending from said modular base to a proximal end;
said proximal end being fastened to a proximal end of a windsock;
said windsock having an inner surface and outer surface adapted to receive said graphic presenting a visual display surface, said windsock further comprising an illuminator;
said illuminator comprising a lens assembly surrounding a light source and in visual communication with a light tunnel, said lens assembly including a lens, a first and second reflector;
said light source operable to emit light and fixed to one end of said light tunnel; and
said first and second reflectors being spaced apart and each presenting a reflective curvilinear surface whereby said emitted light is dispersed to said visual display surface for illumination of said graphic.

2. The apparatus according to claim 1 wherein said stem further comprises an insert and said modular base further comprises a channel whereby said insert is received by said channel.

3. The apparatus according to claim 2 wherein said modular base further comprises a quick release.

4. The apparatus according to claim 1 wherein said modular base further comprises a clip adapted for coupling to the automobile.

5. The apparatus according to claim 1 wherein said stem further comprises an arcuate region.

6. The apparatus according to claim 1 wherein said light source is comprised of a plurality of light emitting diodes.

7. The apparatus according to claim 6 wherein said plurality of light emitting diodes are colored and selected from the group of red, green, blue, and white.

8. The apparatus according to claim 1 wherein said first light reflector is located substantially coaxially along said light tunnel.

9. The apparatus according to claim 1 wherein said second light reflector is oriented perpendicular to the coaxial axis of both the light tunnel and said first light reflector.

10. The apparatus according to claim 1 wherein said windsock shape is frustro-conical.

11. The apparatus according to claim 1 wherein said windsock is joined to said stem at an attachment ring.

12. The apparatus according to claim 11 wherein said attachment ring further comprises tabs for securing said windsock.
